(19) United States
(12) Patent Application Publication
(10) Pub. No.: US 2024/0168882 A1
(43) Pub. Date: May 23, 2024

(54) PROCESSOR AND NETWORK-ON-CHIP COHERENCY MANAGEMENT

(71) Applicant: Akeana, Inc., San Jose, CA (US)

(72) Inventors: Sanjay Patel, San Ramon, CA (US); Hai Ngoc Nguyen, Redwood City, CA (US)

(73) Assignee: Akeana, Inc., San Jose, CA (US)

(21) Appl. No.: 18/515,585

(22) Filed: Nov. 21, 2023

Related U.S. Application Data
(60) Provisional application No. 63/547,574, filed on Nov. 7, 2023.
(60) Provisional application No. 63/547,404, filed on Nov. 6, 2023.
(60) Provisional application No. 63/546,769, filed on Nov. 1, 2023.
(60) Provisional application No. 63/545,961, filed on Oct. 27, 2023.
(60) Provisional application No. 63/542,797, filed on Oct. 6, 2023.
(60) Provisional application No. 63/526,009, filed on Jul. 11, 2023.
(60) Provisional application No. 63/521,365, filed on Jun. 16, 2023.
(60) Provisional application No. 63/471,283, filed on Jun. 6, 2023.
(60) Provisional application No. 63/467,335, filed on May 18, 2023.
(60) Provisional application No. 63/463,371, filed on May 2, 2023.
(60) Provisional application No. 63/462,542, filed on Apr. 28, 2023.
(60) Provisional application No. 63/444,619, filed on Feb. 10, 2023.
(60) Provisional application No. 63/439,761, filed on Jan. 18, 2023.
(60) Provisional application No. 63/436,133, filed on Dec. 30, 2022.
(60) Provisional application No. 63/436,144, filed on Dec. 30, 2022.
(60) Provisional application No. 63/435,831, filed on Dec. 29, 2022.
(60) Provisional application No. 63/435,343, filed on Dec. 27, 2022.
(60) Provisional application No. 63/434,104, filed on Dec. 21, 2022.
(60) Provisional application No. 63/431,756, filed on Dec. 12, 2022.
(60) Provisional application No. 63/430,700, filed on Dec. 7, 2022.
(60) Provisional application No. 63/427,109, filed on Nov. 22, 2022.

(51) Int. Cl. G06F 12/0817

(52) U.S. Cl. CPC G06F 12/0828; G06F 2212/621

(57) ABSTRACT

Techniques for coherency management based on processor and network-on-chip coherency management are disclosed. A plurality of processor cores is accessed. Each processor of the plurality of processor cores accesses a common memory through a coherent network-on-chip. The coherent network-on-chip comprises a global coherency. A local cache is coupled to a grouping of two or more processor cores. The local cache is shared among the two or more processor cores. The grouping of two or more processor cores and the shared local cache operates using local coherency. The local coherency is distinct from the global coherency. A cache maintenance operation is performed in the grouping of two or more processor cores and the shared local cache. The cache maintenance operation generates cache coherency transactions between the global coherency and the local coherency. The cache coherency transactions enable coherency among the plurality of processor cores, local caches, and the memory.

### RELATED APPLICATIONS

This application claims the benefit of U.S. provisional patent applications “Processor and Network-On-Chip Coherency Management” Ser. No. 63/427,109, filed Nov. 22, 2022, “Processor Instruction Exception Handling” Ser. No. 63/430,700, filed Dec. 7, 2022, “Branch Target Buffer Operation With Auxiliary Indirect Cache” Ser. No. 63/431,756 filed Dec. 12, 2022, “Processor Performance Profiling Using Agents” Ser. No. 63/434,104, filed Dec. 21, 2022, “Prefetching With Saturation Control” Ser. No. 63/435,343, filed Dec. 27, 2022, “Prioritized Unified TLB Lookup With Variable Page Sizes” Ser. No. 63/435,831, filed Dec. 29, 2022, “Return Address Stack With Branch Mispredict Recovery” Ser. No. 63/436,133, filed Dec. 30, 2022, “Coherency Management Using Distributed Snoop” Ser. No. 63/436,144, filed Dec. 30, 2022, “Cache Management Using Shared Cache Line Storage” Ser. No. 63/439,761, filed Jan. 18, 2023, “Access Request Dynamic Multilevel Arbitration” Ser. No. 63/444,619, filed Feb. 10, 2023, “Processor Pipeline For Data Transfer Operations” Ser. No. 63/462,542, filed Apr. 28, 2023, “Out-Of-Order Unit Stride Data Prefetcher With Scoreboarding” Ser. No. 63/463,371, filed May 2, 2023, “Architectural Reduction Of Voltage And Clock Attach Windows” Ser. No. 63/467,335, filed May 18, 2023, “Coherent Hierarchical Cache Line Tracking” Ser. No. 63/471,283, filed Jun. 6, 2023, “Direct Cache Transfer With Shared Cache Lines” Ser. No. 63/521,365, filed Jun. 16, 2023, “Polarity-Based Data Prefetcher With Underlying Stride Detection” Ser. No. 63/526,009, filed Jul. 11, 2023, “Mixed-Source Dependency Control” Ser. No. 63/542,797, filed Oct. 6, 2023, “Vector Scatter And Gather With Single Memory Access” Ser. No. 63/545,961, filed Oct. 27, 2023, “Pipeline Optimization With Variable Latency Execution” Ser. No. 63/546,769, filed Nov. 1, 2023, “Cache Evict Duplication Management” Ser. No. 63/547,404, filed Nov. 6, 2023, and “Multi-Cast Snoop Vectors Within A Mesh Topology” Ser. No. 63/547,574, filed Nov. 7, 2023.

Each of the foregoing applications is hereby incorporated by reference in its entirety.

### FIELD OF ART

This application relates generally to coherency management and more particularly to processor and network-on-chip coherency management.

### BACKGROUND

Integrated circuits, which are more commonly referred to as “chips”, are present in nearly every imaginable product. The products can range from personal to domestic to lifestyle to transportation and beyond. The products that contain chips can include personal care items such as electric toothbrushes. Unlike manual toothbrushes which are limited by the skill and attention of the user, electric toothbrushes can enhance dental hygiene by offering a variety of speeds and brushing actions. Integrated circuits are used in domestic items such as kitchen appliances. The kitchen appliances can now offer features that exceed mere speed control, instead offering options that can even prepare foods requiring advanced kitchen skills. Even the lowly thermostat has advanced beyond a temperature sensitive on-off switch. Now, thermostats contain integrated circuits which enable the thermostats to learn the occupant usage patterns of various rooms within a house, school, or office. The thermostats can even switch to an “eco” mode that reduces energy usage and energy costs for heating and cooling. Integrated circuits make all of these previously dull devices more capable, useful, and fun.

Integrated circuits are widely known to be present in electronic devices such as smartphones, tablets, televisions, laptop computers and desktop computers, gaming consoles, and more. The chips enable and greatly enhance device features and utility. These device features render the devices more useful and more central to the users' lives than were even recent, earlier generations of the devices. Many toys and games have benefited from the incorporation of integrated circuits. The chips enhance the games by better engaging players ranging from “first timers” to seasoned veterans. Further, the chips can produce remarkably realistic audio and graphics, enabling players to engage mysterious and exotic digital worlds and situations. The games support single participant and team play, encouraging players to join together to participate. The chip-enhanced games can even enable players to join the fun from locations around the world. The players can equip themselves with virtual reality headsets that enable players to be immersed in virtual worlds, surrounded by computer generated graphics and 3-D audio. Integrated circuits often contain processors, and sometimes even multiple processors.

Integrated circuits are found in vehicles of all types. As new features are added to the vehicles, increasing numbers of chips can be used. The chips improve fuel economy and vehicle operating efficiency, vehicle safety, user comfort, and user entertainment. Integrated circuits are found in vehicles ranging from manually operated ones to semiautonomous and autonomous vehicles. Vehicle safety features include proximity to other vehicles, vehicle drifting, and even driver status. The chips can be used to allow or prevent user access to the vehicle, and even to take over operation of the vehicle if the user falls asleep or experiences a medical emergency. The integrated circuits found in these widely ranging devices and applications greatly enrich overall user experience by adding desirable features that were previously unavailable.

### SUMMARY

Processors of various types are found in devices ranging from personal electronic devices to computers, to specialty devices such as medical equipment, to household appliances, and to vehicles, to name only a few applications. The processors enable the devices within which the processors are located to execute a wide variety of applications. The applications include telephony, messaging, data processing, patient monitoring, vehicle access and operation control, etc. The processors are coupled to additional elements that enable the processors to execute their assigned applications. The additional elements typically include one or more of shared, common memories, communications channels, peripherals, and so on. In order to boost processor performance, and to take advantage of “locality” often found in application code that is executed by the processors, portions of the contents of the common memories can be moved to cache memory. The cache memory, which can be colocated with or closely adjacent to the processors, is often smaller and faster than the common memory. The cache memory can be accessed by some or all of the processors without having to access the slower common memory, thereby reducing access time and increasing processing speed. Access by the processors to the cache memory can continue while data, instructions, etc. are available within the cache. If the requested data is not located within the cache, then a cache miss occurs, and the processors must reach out to the slower, shared, common memory for the requested data. Rather than simply providing the data associated with the one request, another portion of the contents of the common memory can be transferred to the cache, and processor operation can continue.

As the processors access and process or manipulate data within the cache memory, an inconsistency or incoherence develops between the data within the cache and the data within the common memory. The incoherent, or “dirty”, data must be made coherent with the data in the common memory at some point during the execution of an application. The making coherent the data within the cache and the data within the common memory is accomplished using coherency management. The coherency management is based on cache maintenance operations. Depending on the application that is being executed by the processors and operations that can manipulate data, at some times during application execution the data within the shared memory can be valid or newer while the data within the cache can be invalid or older. At other times, the data within the cache can be valid or newer while the data within the common memory can be invalid or older. The cache maintenance operations are used to enable coherency between the common memory and one or more shared caches.

Coherency management is enabled by processor and network-on-chip coherency management. Techniques for coherency management based on processor and network-on-chip coherency management are disclosed. A plurality of processor cores is accessed. Each processor of the plurality of processor cores accesses a common memory through a coherent network-on-chip. The coherent network-on-chip comprises a global coherency. A local cache is coupled to a grouping of two or more processor cores. The local cache is shared among the two or more processor cores. The grouping of two or more processor cores and the shared local cache operates using local coherency. The local coherency is distinct from the global coherency. A cache maintenance operation is performed in the grouping of two or more processor cores and the shared local cache. The cache maintenance operation generates cache coherency transactions between the global coherency and the local coherency. The cache coherency transactions enable coherency among the plurality of processor cores, local caches, and the memory.

A processor-implemented method for coherency management is disclosed comprising: accessing a plurality of processor cores, wherein each processor of the plurality of processor cores accesses a common memory through a coherent network-on-chip, and wherein the coherent network-on-chip comprises a global coherency; coupling a local cache to a grouping of two or more processor cores of the plurality of processor cores, wherein the local cache is shared among the two or more processor cores, wherein the grouping of two or more processor cores and the shared local cache operates using local coherency, and wherein the local coherency is distinct from the global coherency; and performing a cache maintenance operation in the grouping of two or more processor cores and the shared local cache, wherein the cache maintenance operation generates cache coherency transactions between the global coherency and the local coherency. Some embodiments comprise coupling an additional local cache to an additional grouping of two or more additional processor cores. In embodiments, the additional local cache is shared among the additional grouping of two or more additional processor cores and operates using the local coherency. In embodiments, the grouping of two or more processor cores and the shared local cache is interconnected to the grouping of two or more additional processor cores and the shared additional local cache using the coherent network-on-chip.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for processor and network-on-chip coherency management.

FIG. 2 is a flow diagram for cache coherency transactions.

FIG. 3 is a system block diagram showing processor cores with coherency management.

FIG. 4 is a block diagram illustrating a RISC-V processor.

FIG. 5 is a block diagram for a pipeline.

FIG. 6 is a table showing cache maintenance operations (CMOs).

FIG. 7 is a system diagram for processor and network-on-chip coherency management.

### DETAILED DESCRIPTION

Techniques for coherency management are enabled using processor and network-on-chip coherency management. A processor, such as a standalone processor, a processor chip, a processor core, and so on, can be used to perform data processing tasks. The processing of data can be significantly enhanced by using two or more processors to process the data. The processors can be performing substantially similar operations, where the processors can process different portions or blocks of data in parallel. The processors can be performing substantially different operations, where the processors can process different blocks of data or may try to perform different operations on the same data. Whether the operations performed by the processors are substantially similar or not, managing how processors access data, and whether the data is unprocessed or processed, is critical to successfully processing the data.

In order to increase the speed of operations such as data processing operations, a cache memory can be used. A cache memory, which is typically smaller and faster than a shared, common memory, can be coupled between the common memory and the processors. As the processors process data, they search first for an address containing the data within the cache memory. If the address is not present within the cache, then a “cache miss” occurs, and the data requested by the processors can be obtained from an address within the common memory. Use of the cache memory for data access by one or more processors is preferable because of reduced latency associated with accessing the cache memory as opposed to the common memory. The accessing data within the cache is further enhanced due to the “locality of reference”. Code, as it is being executed, tends to access a substantially similar set of memory addresses, whether the memory addresses are located in the common memory or the cache memory. By loading the contents of a set of common memory addresses into the cache, the processors are more likely to find the requested data within the cache and can obtain the requested data sooner than obtaining the requested data from the common memory. Due to the smaller size of the cache with respect to the common memory, a cache miss can occur when the requested memory address is not located within the cache. One technique that can be implemented is to load a new block of data from the common memory into the cache memory, where the new block contains the requested address. Thus, processing can again continue by accessing the faster cache rather than the slower common memory.

The processors can read data from a memory such as the cache memory, process the data, then write the processed data back to the cache. As a result, the contents of the cache can be different from the contents of the common memory. To remedy this state so that the common memory and the cache memory are “in sync”, coherency management techniques can be used. A similar problem can occur when out of date data remains in the cache after the contents of the common memory are updated. Again, this state can be remedied using coherency management techniques. In embodiments, additional local caches can be coupled to groupings of processors. While the additional local caches can greatly increase processing speed, the additional caches further complicate coherency management. Techniques presented herein address coherency management between common memory and the caches, and coherency management among the caches.

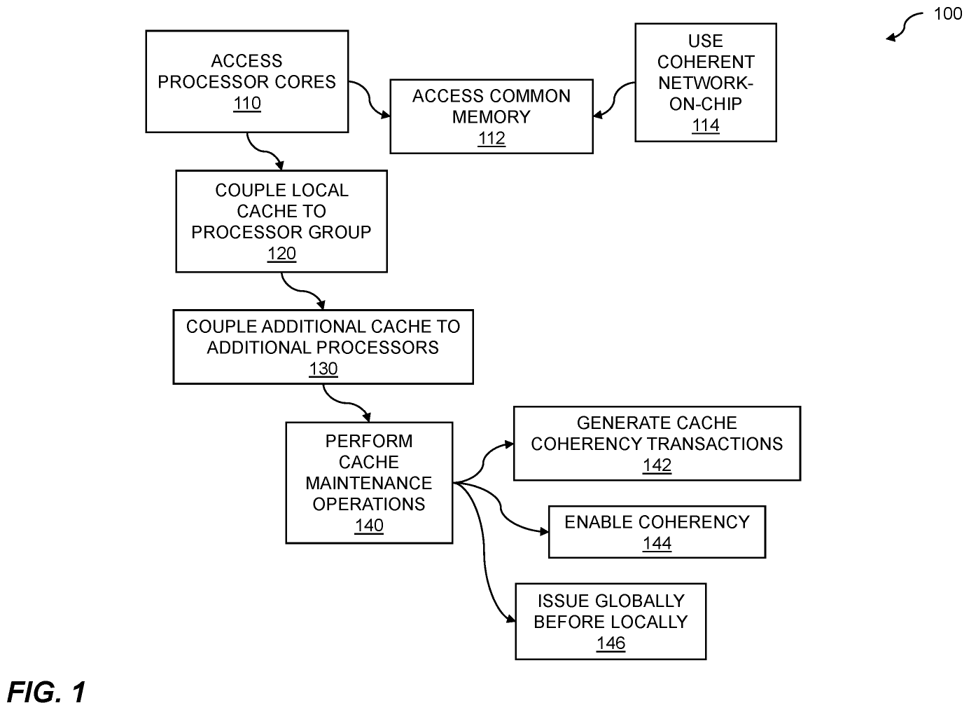

FIG. 1 is a flow diagram for processor and network-on-chip coherency management. A processor can include a multicore processor such as a RISC-V™ processor. The processor cores can include homogeneous processor cores or heterogeneous processor cores. The cores that are included can have substantially similar capabilities or substantially different capabilities. The processor cores can include further elements. The further elements can include one or more of physical memory protection (PMP) elements, memory management (MMU) elements, level 1 (L1) caches such as instruction caches and data caches, level 2 (L2) caches, and the like. The multicore processor can further include a level 3 (L3) cache, test and debug support such as joint test action group (JTAG) elements, a platform level interrupt controller (PLIC), an advanced core local interrupter (ACLINT), and so on. In addition to the elements just described, the multicore processor can include one or more interfaces. The interfaces can include one or more industry standard interfaces, interfaces specific to the multicore processor, and the like. In embodiments, the interfaces can include an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. The interfaces can enable connection between the multicore processor and an interconnect. In embodiments, the interconnect can include an AXI™ interconnect. The interconnect can enable the multicore processor to access a variety of peripherals such as storage elements, communications elements, etc.

The flow 100 includes accessing a plurality of processor cores 110. The processor cores can include homogeneous processor cores, heterogeneous processor cores, and so on. The cores can include general purpose cores, specialty cores, custom cores, etc. In embodiments, the cores can be associated with a multicore processor such as a RISC-V™ processor. The cores can be included in one or more integrated circuits or “chips”, application-specific integrated circuits (ASICs), programmable gate arrays (PGAs), and the like. In the flow 100, each processor of the plurality of processor cores accesses 112 a common memory. The common memory can include a memory comprising one or more integrated circuits, a memory colocated with the plurality of processor cores in an arrangement such as a system on chip (SoC), etc. The common memory can include a single port memory, a multiport memory, and the like. In the flow 100, access to the common memory is accomplished through a coherent network-on-chip 114, where the coherent network-on-chip comprises a global coherency. A network-on-chip can comprise a subsystem, on an integrated circuit, which can be used to enable communications among various elements on a system-on-chip. The coherent network-on-chip can include coherency messaging (e.g., cache coherency transactions) and cache miss requests. The network-on-chip can handle message tracking and forwarding in order to anticipate future cache block requests. The message tracking and forwarding can be used to broadcast requested cache blocks to cores such as processor cores that may request the cache blocks in the future.

The flow 100 includes coupling a local cache to a grouping of two or more processor cores 120 of the plurality of processor cores, wherein the local cache is shared among the two or more processor cores, wherein the grouping of two or more processor cores and the shared local cache operates using local coherency, and wherein the local coherency is distinct from the global coherency. The local cache can include a smaller, faster memory in comparison to the common memory to which the processor cores have access. In embodiments, the grouping of two or more processor cores and the shared local cache can comprise a tightly coupled compute coherency block. The local cache can include a single level cache, a multilevel cache, and so on. In embodiments, the local cache can act as a higher-level cache to one or more caches that can be associated with a processor core. In a usage example, the local cache can be coupled to a grouping of processors such as RISC-V™ processors. Each RISC-V processor can include a level 1 (L1) instruction cache, an L1 data cache, and a shared level 2 (L2) cache. Thus, the local cache that is coupled to the two or more RISC-V processors can serve as a level 3 (L3) cache. Since the local cache is coupled to a grouping of two or more processor cores, each processor core can load the contents of the local cache, process the contents, and store results back to the local cache. In order to avoid the risk of overwriting cache contents that are needed by a processor core other than the core doing the writing, a processor core reading out of date data, and other memory access “hazards”, local coherency is maintained.

The flow 100 further includes coupling an additional local cache 130 to an additional grouping of two or more additional processor cores. The additional local cache can include an amount of storage that is substantially similar to the amount of storage of the first local cache, or can include an amount of storage that is substantially different from the first local cache. The additional grouping of processor cores can include a substantially similar number of cores to the first grouping, or a substantially different number of cores. In embodiments, the additional local cache is shared among the additional grouping of two or more additional processor cores, and operates using the local coherency. As for the first local cache and the first local grouping, the additional grouping of two or more processor cores and the shared local cache can comprise a tightly coupled compute coherency block. In embodiments, the grouping of two or more processor cores and the shared local cache is interconnected to the grouping of two or more additional processor cores and the shared additional local cache using the coherent network-on-chip. As for the first cache, which reduces access times for acquiring data and instructions in comparison to access common memory, the use of an additional local cache can reduce access times for the additional grouping of processors.

The flow 100 includes performing 140 cache maintenance operations in the grouping of two or more processor cores and the shared local cache. The cache maintenance operations can be used to maintain coherency among the common memory, the local caches, the processor cores, and so on. Discussed previously and throughout, the cache maintenance operations can perform cache maintenance-related tasks such as zeroing, cleaning, flushing, invalidating, and so on. The cache maintenance operations can be performed on the local caches and associated processor cores to maintain local coherency, on two or more local cores and the common memory to maintain global coherency, and the like. In embodiments, the cache maintenance operation can be a privileged instruction within the plurality of processor cores. The privileged instructions can require a high permission level in order to execute the instructions. Making the instructions privileged greatly reduces the risk that coherency is ignored, improperly maintained, accessed by unauthorized code, etc.

In the flow 100, the cache maintenance operation generates 142 cache coherency transactions between the global coherency and the local coherency. The cache coherency transactions can include transactions associated with a standard, a processor core, and so on. In embodiments, the transactions can include an Advanced extensible Interface (AXI™) such as AXI4™ transactions, ARM™ Advanced extensible Interface (AXI™) Coherence Extensions (ACE™) interface transactions, Advanced Microcontroller Bus Architecture (AMBA™) Coherence Hub Interface (CHI™) transactions, etc. In embodiments, the cache maintenance operations can include cache block operations. A cache block can include a portion of a cache. The portion of the cache can be loaded with a corresponding portion of a memory such as the common memory. The cache block can include a number of bytes such as 4 bytes, 8 bytes, 16 bytes, etc. In embodiments, the cache block operations can include a cache line zeroing operation, a cache line cleaning operation, a cache line flushing operation, and a cache line invalidating operation. The cache line operations are discussed in detail below.

In embodiments, the cache block operations can be used to maintain coherency between a local cache and a grouping of processors, among local caches, among local caches and the common memory, and so on. In embodiments, the cache line zeroing operation can include uniquely allocating a cache line at a given physical address with a zero value. The overwriting with the zero value can clear previous data. The zero value can indicate a reset, a preset, or a similar value. In embodiments, the cache line cleaning operation can include making all copies of a cache line at a given physical address consistent with the corresponding cache line in the common memory. One or more local caches can contain a copy of the cache line. The line cleaning operation can ensure that all copies of the cache line are consistent, that is, coherent, with the shared memory contents. In other embodiments, the cache line flushing operation can include flushing any dirty data for a cache line at a given physical address to memory and then invalidating any and all copies. Data that can result from processing a local copy of data within a local cache can be stored to the local cache, thereby changing the contents of the local cache. The contents of the local cache are said to be “dirty” since they have been changed or modified and no longer match the original cache line, block, etc. The data within the local cache can be written to the common memory to update the contents of the physical address in the common memory. In further embodiments, the cache line invalidating operation can include invalidating any and all copies of a cache line at a given physical address without flushing dirty data. Having flushed data from a local cache to update the data at a corresponding location or physical address in the common memory, all remaining copies of the old data within other local caches becomes invalid.

In the flow 100, the cache coherency transactions enable coherency 144 among the plurality of processor cores, the one or more local caches, and the memory. Discussed in detail below, the coherency is enabled by mapping cache block operations (CBOs) to ACE™ and CHI™ transactions. The ACE™ and CHI™ transactions that are mapped from a given cache block operation can differ depending on whether the transaction is performed, referenced from a core to other cores globally, or referenced to cores locally. In the flow 100, the cache coherency transactions are issued globally before being issued locally 146. That is, the CBO, while originating in a processor, is sent first to a global ordering point. After being ordered, the resultant transaction is then sent for local processing where it is converted to a Read_Shared or Read_Unique operation, as described later. The issuing globally can ensure that updated data is properly stored to a shared memory such as the common memory, that access conflicts such as store access conflicts are reduced or eliminated, etc. In embodiments, the cache coherency transactions that are issued globally can complete before cache coherency transactions are issued locally. The global cache coherency transactions can be prioritized over the local transaction to maintain data integrity among the common memory, local caches, and processor cores. In embodiments, an indication of completeness can include a response from the coherent network-on-chip. The response can include a flag, a semaphore, a signal, a message, and so on. In embodiments, an indication of completion can include a response from the coherent network-on-chip.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

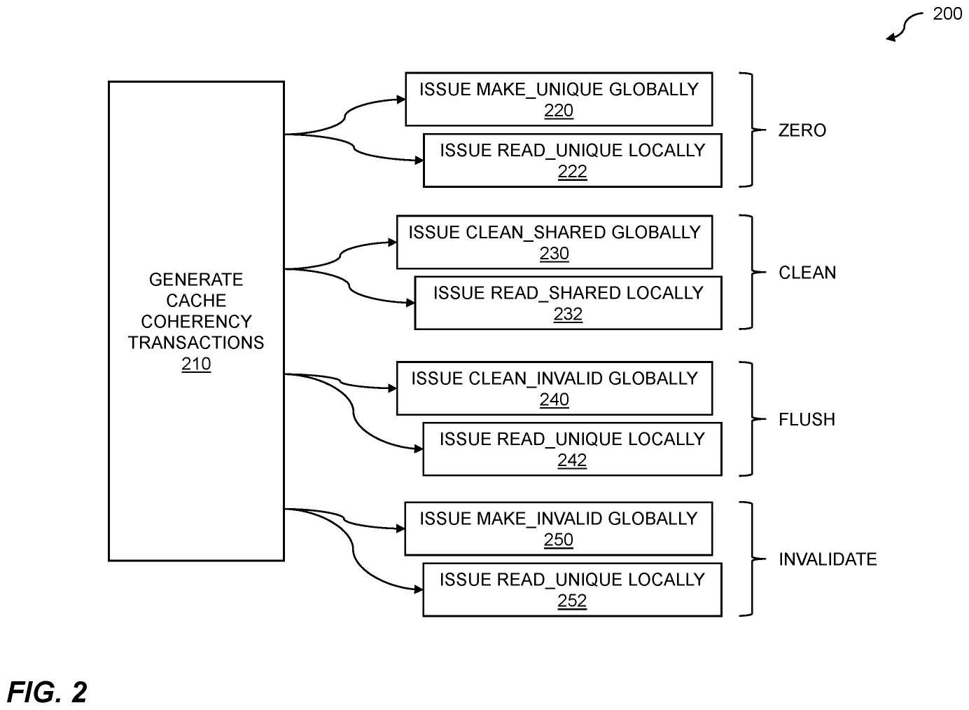

FIG. 2 is a flow diagram for cache coherency transactions. Cache coherency transactions can be generated, where the cache coherency transactions can enable coherency of a local cache and a grouping of processors to which the local cache is coupled; can enable coherency among additional local caches, where the additional local caches are coupled to additional groupings of processors; and can enable coherency between the common memory and the local caches. The cache coherency transactions enable processor and network-on-chip coherency management. A plurality of processor cores is accessed, wherein each processor of the plurality of processor cores accesses a common memory through a coherent network-on-chip, wherein the coherent network-on-chip comprises a global coherency. A local cache is coupled to a grouping of two or more processor cores of the plurality of processor cores, wherein the local cache is shared among the two or more processor cores, wherein the grouping of two or more processor cores and the shared local cache operates using local coherency, and wherein the local coherency is distinct from the global coherency. A cache maintenance operation is performed in the grouping of two or more processor cores and the shared local cache, wherein the cache maintenance operation generates cache coherency transactions between the global coherency and the local coherency.

The flow 200 includes generating cache coherency transactions 210. A cache coherency transaction is generated by a cache maintenance operation. Discussed throughout, the cache maintenance operation can include zeroing, cleaning, flushing, invalidating, and so on one or more caches such as local caches. The cache maintenance operation can be performed in a grouping of two or more processor cores and a local cache coupled to the processor cores. The cache coherency transactions that are generated perform cache maintenance between global coherency and local coherency. Global coherency can include coherency between the common memory and the local caches. Local coherency can include coherency between a local cache and the grouping of processors coupled to the local cache. The cache coherency transactions are issued globally before being issued locally. That is, cache block operations (CBOs), while originating in a processor, are sent first to a global ordering point. After being ordered, the resultant transactions are then sent for local processing where they are converted to Read_Shared or Read_Unique operations, as is described later.

In embodiments, the cache maintenance operation can include cache block operations. A cache block can include a portion or block of common memory contents, where the block can be moved from the common memory into a local cache. In embodiments, the cache block operations can include a cache line zeroing operation, a cache line cleaning operation, a cache line flushing operation, and a cache line invalidating operation. These operations are discussed in detail below. The cache block operations can be used to maintain coherency. In embodiments, the cache line zeroing operation can include uniquely allocating a cache line at a given physical address with a zero value. The zero value can be used to overwrite and thereby clear previous data. The zero value can indicate a reset value. The cache line can be set to a nonzero value if appropriate. In embodiments, the cache line cleaning operation can include making all copies of a cache line at a given physical address consistent with that of memory. Recall that the processors can be arranged in groupings of two or more processors and that each grouping can be coupled to a local cache. One or more of the local caches can contain a copy of the cache line. The line cleaning operation can set or make all copies of the cache line consistent with the shared memory contents. In other embodiments, the cache line flushing operation can include flushing any dirty data for a cache line at a given physical address to memory and then invalidating any and all copies. The “dirty” data can result from processing a local copy of data within a local cache. The data within the local cache can be written to the common memory to update the contents of the physical address in the common memory. In further embodiments, the cache line invalidating operation can include invalidating any and all copies of a cache line at a given physical address without flushing dirty data. Having flushed data from a local cache to update the data at a corresponding location or physical address in the common memory, all remaining copies of the old data within other local caches becomes invalid.

The cache line instructions just described can be mapped to standard operations or transactions for cache maintenance, where the standard transactions can be associated with a given processor type. In embodiments, the processor type can include a RISC-V™ processor core. The standard cache maintenance transactions can differ when transactions occur from the cores and when transactions occur to the cores. The transactions can comprise a subset of cache maintenance operations, transactions, and so on. The subset of operations can be referred to as cache block operations (CBOs). The cache block operations can be mapped to standard transactions associated with an ARM™ Advanced extensible Interface (AXI™) Coherence Extensions (ACE™) interface, an Advanced Microcontroller Bus Architecture (AMBA™) Coherence Hub Interface (CHI™), etc. In embodiments, the cache coherency transactions can be issued globally before being issued locally. A globally issued transaction can include a transaction that enables cache coherency from a core to cores globally. The issuing cache coherency transactions globally can prevent invalid data being processed by processor cores using local, outdated copies of the data. The issuing cache coherency transactions locally can maintain coherence within compute coherency blocks (CCBs) such as groupings of processors. In embodiments, the cache coherency transactions that are issued globally can complete before cache coherency transactions are issued locally. A variety of indicators can be used to signify completion, such as a flag, a semaphore, a message, a code, and the like. In embodiments, an indication of completeness can include a response from the coherent network-on-chip.

Recall that the cache transactions can include cache line zeroing, cache line cleaning, cache line flushing, cache line invalidating, and so on, and that the cache coherency transactions are issued globally before being issued locally. In the flow 200, the cache coherency transactions include issuing a Make_Unique operation globally 220 and a Read_Unique operation locally 222, based on a cache maintenance operation of cache line zeroing. The Make_Unique transaction can hold a cache line in a unique state. Holding the cache line in a unique state can enable a write or store operation to the cache line, but does not retain a copy of the data. Other copies of the cache line can be removed. The locally issued Read_Unique operation can be based on a snoop channel, such as an ACE™ snoop address channel (AC). In the flow 200, the cache coherency transactions include issuing a Clean_Shared operation globally 230 and a Read_Shared operation locally 232, based on a cache maintenance operation of cache line cleaning. The locally issued Read_Shared operation can be based on a snoop channel, such as an ACE™ snoop address channel (AC). The Clean_Shared operation can include a broadcast of clean data to caches so that all cached copies of the data can be clean. The Read_Shared operation can include loading shared data into local caches. In the flow 200, the cache coherency transactions include issuing a Clean_Invalid operation 240 globally and a Read_Unique operation 242 locally, based on a cache maintenance operation of cache line flushing. The Clean_Invalid operation can include broadcasting cache clean and cache invalid operations. The Clean_Invalid operation can be used to ensure that common memory is updated and that there are no cached copies. The locally issued Read_Unique operation can load clean data into the local caches. In the flow 200, the cache coherency transactions include issuing a Make_Invalid operation 250 globally and a Read_Unique operation 252 locally, based on a cache maintenance operation of cache line invalidating. The globally issued Make_Invalid operation can broadcast a cache invalidate operation. The Make_Invalid operation can be used to ensure that no cached copies of data remain. The locally issued Read_Unique operation loads clean data into the caches.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

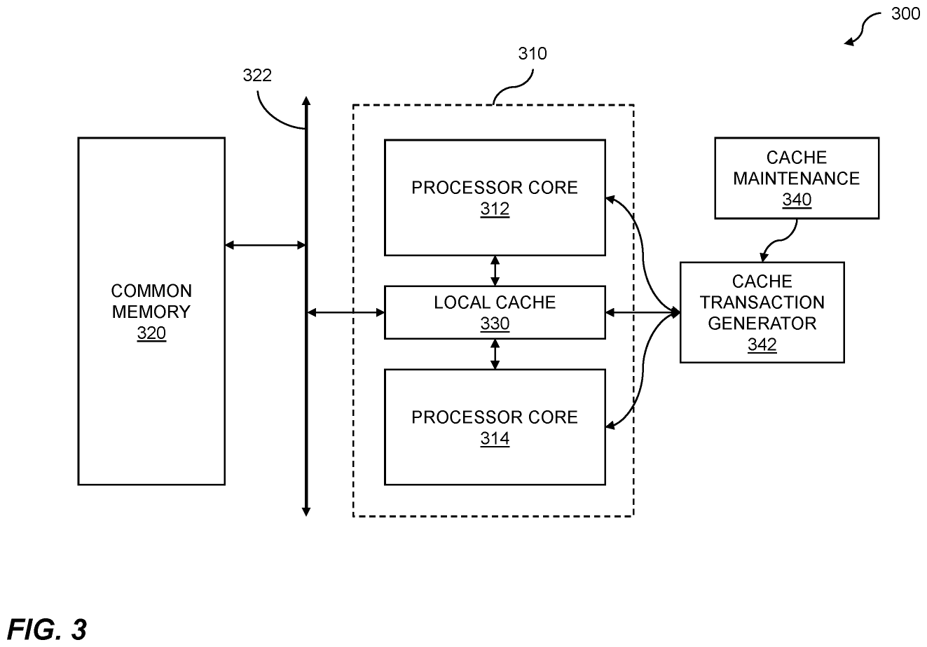

FIG. 3 is a system block diagram showing processor cores with coherency management. Described previously and throughout, groupings of processor cores can be coupled to a local cache. The local cache can be loaded with data from a source such as a shared memory. The processors coupled to the local cache can process the data, causing the data to become “dirty” or different from the contents of the shared memory. Since multiple groupings of processors can each be coupled to their own local caches, the problem of incoherency between the contents of the shared memory and the local caches becomes highly complex. To resolve the coherency challenges, one or more coherency management operations can be applied to the data within the local caches and the shared memory. The coherency management enables processor and network-on-chip coherency. A plurality of processor cores is accessed, wherein each processor of the plurality of processor cores accesses a common memory through a coherent network-on-chip, and wherein the coherent network-on-chip comprises a global coherency. A local cache is coupled to a grouping of two or more processor cores of the plurality of processor cores, wherein the local cache is shared among the two or more processor cores, wherein the grouping of two or more processor cores and the shared local cache operates using local coherency, and wherein the local coherency is distinct from the global coherency. A cache maintenance operation is performed in the grouping of two or more processor cores and the shared local cache, wherein the cache maintenance operation generates cache coherency transactions between the global coherency and the local coherency.

A system block diagram 300 of processor cores with coherency management is shown. A multicore processor 310 can include a plurality of processor cores. The processor cores can include homogeneous processor cores, heterogeneous cores, and so on. In the system block diagram 300, two processor cores are shown, processor core 312 and processor core 314. The processor cores can be coupled to a common memory 320, often through a cache (described below). The common memory can be shared by a plurality of multicore processors. The common memory can be coupled to the plurality of processor cores through a coherent network-on-chip 322. The network-on-chip can be colocated with the plurality of processor cores within an integrated circuit or chip, an application-specific integrated circuit (ASIC), a field programmable gate array (FPGA), and so on. The network-on-chip can be used to interconnect the plurality of processor cores and other elements within a system-on-chip (SoC) architecture. The network-on-chip can support coherency between the common memory 320 and one or more local caches (described below) using coherency transactions. In embodiments, the cache coherency transactions can enable coherency among the plurality of processor cores, one or more local caches, and the memory. The cache coherency can be accomplished based on coherency messages, cache misses, and the like.

The system block diagram 300 can include a local cache 330. The local cache can be coupled to a grouping of two or more processor cores within a plurality of processor cores. In addition to communicating with the grouping of two or more processor cores, the local cache can communicate with an on-chip network or bus, an off-chip network or bus, an on-chip memory, an off-chip memory, an additional non-local cache, other coherent or non-coherent bus structures, and so on. The local cache can include a multilevel cache. In embodiments, the local cache can be shared among the two or more processor cores. The cache can include a multiport cache. In embodiments, the grouping of two or more processor cores and the shared local cache can operate using local coherency. The local coherency can indicate to processors associated with a grouping of processors that the contents of the cache have been changed or made “dirty” by one or more processors within the grouping. In embodiments, the local coherency is distinct from the global coherency. That is, the coherency maintained for the local cache can be distinct from coherency between the local cache and the common memory, coherency between the local cache and one or more further local caches, etc.

The system block diagram 300 can include a cache maintenance element 340. The cache maintenance element can maintain local coherency of the local cache, coherency between the local cache and the common memory, coherency among local caches, and so on. The cache maintenance can be based on issuing cache transactions. In the system block diagram 300, the cache transaction can be provided by a cache transaction generator 342. In embodiments, the cache coherency transactions can enable coherency among the plurality of processor cores, one or more local caches, and the memory. The contents of the caches can become “dirty” by being changed. The cache contents changes can be accomplished by one or more processors processing data within the caches, by changes made to the contents of the common memory, and so on. In embodiments, the cache coherency transactions can be issued globally before being issued locally. Issuing the cache coherency transactions globally can ensure that the contents of the local caches are coherent with respect to the common memory. Issuing the cache coherency transactions locally can ensure coherency with respect to the plurality of processors within a given grouping. In embodiments, the cache coherency transactions that are issued globally can complete before cache coherency transactions are issued locally. The completion of the coherency transaction issued globally can include a response from the coherent network-on-chip.

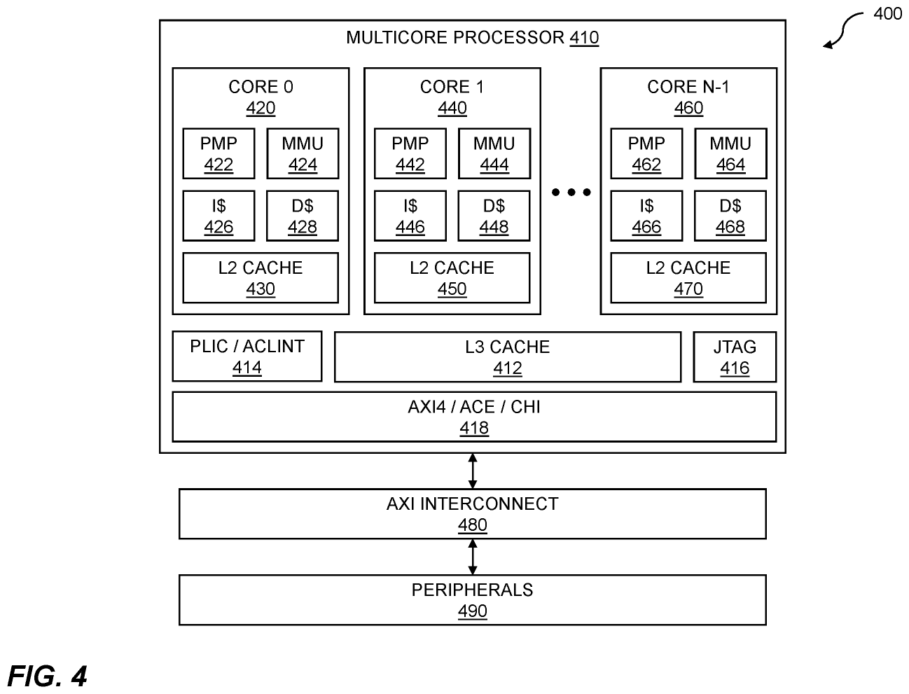

FIG. 4 is a block diagram illustrating a RISC-V™ processor. The processor can include a multi-core processor, where two or more processor cores can be included. The processor such as a RISC-V™ processor can include a variety of elements. The elements can include processor cores, one or more caches, memory protection and management units, local storage, and so on. The elements of the multicore processor can further include one or more of a private cache, a test interface such as a joint test action group (JTAG) test interface, one or more interfaces to a network such as a network-on-chip, shared memory, peripherals, and the like. The multicore processor is enabled by processor and network-on-ship coherency management. A plurality of processor cores is accessed. Each processor of the plurality of processor cores accesses a common memory through a coherent network-on-chip, and the coherent network-on-chip comprises a global coherency. A local cache is coupled to a grouping of two or more processor cores of the plurality of processor cores. The local cache is shared among the two or more processor cores. The grouping of two or more processor cores and the shared local cache operates using local coherency, and the local coherency is distinct from the global coherency. A cache maintenance operation is performed in the grouping of two or more processor cores and the shared local cache. The cache maintenance operation generates cache coherency transactions between the global coherency and the local coherency.

The block diagram 400 can include a multicore processor 410. The multicore processor can comprise two or more processors, where the two or more processors can include homogeneous processors, heterogeneous processors, etc. In the block diagram, the multicore processor can include N processor cores such as core 0 420, core 1 440, core N−1 460, and so on. Each processor can comprise one or more elements. In embodiments, each core, including cores 0 through core N−1 can include a physical memory protection (PMP) element, such as PMP 422 for core 0; PMP 442 for core 1, and PMP 462 for core N−1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 424 for core 0, MMU 444 for core 1, and MMU 464 for core N−1. The memory management units can translate virtual addresses used by software running on the cores to physical memory addresses with caches, the share memory system, etc.

The processor cores associated with the multicore processor 410 can include caches such as instruction caches and data caches. The caches, which can comprise level 1 (L1) caches, can include an amount of storage such as 16 KB, 32 KB, and so on. The caches can include an instruction cache I$ 426 and a data cache D$ 428 associated with core 0; an instruction cache I$ 446 and a data cache D$ 448 associated with core 1; and an instruction cache I$ 466 and a data cache D$ 468 associated with core N−1. In addition to the level 1 instruction and data caches, each core can include a level 2 (L2) cache. The level 2 caches can include L2 cache 430 associated with core 0; L2 cache 450 associated with core 1; and L2 cache 470 associated with core N−1. The cores associated with the multicore processor 410 can include further components or elements. The further elements can include a level 3 (L3) cache 412. The level 3 cache, which can be larger than the level 1 instruction and data caches, and the level 2 caches associated with each core, can be shared among all of the cores. The further elements can be shared among the cores. In embodiments, the further elements can include a platform level interrupt controller (PLIC) 414. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 416. The JTAG can provide a boundary within the cores of the multicore processor. JTAG can enable fault information to a high precision. The high-precision fault information can be critical to rapid fault detection and repair.

The multicore processor 410 can include one or more interface elements 418. The interface elements can support standard processor interfaces such as an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 400, the interface elements can be coupled to the interconnect. The interconnect can include a bus, a network, and so on. The interconnect can include an AXI™ interconnect 480. In embodiments, the network can include network-on-chip functionality. The AXI™ interconnect can be used to connect memory-mapped “master” or boss devices to one or more “slave” or worker devices. In the block diagram 400, the AXI interconnect can provide connectivity between the multicore processor 410 and one or more peripherals 490. The one or more peripherals can include storage devices, networking devices, and so on. The peripherals can enable communication using the AXI™ interconnect by supporting standards such as AMBA™ version 4, among other standards.

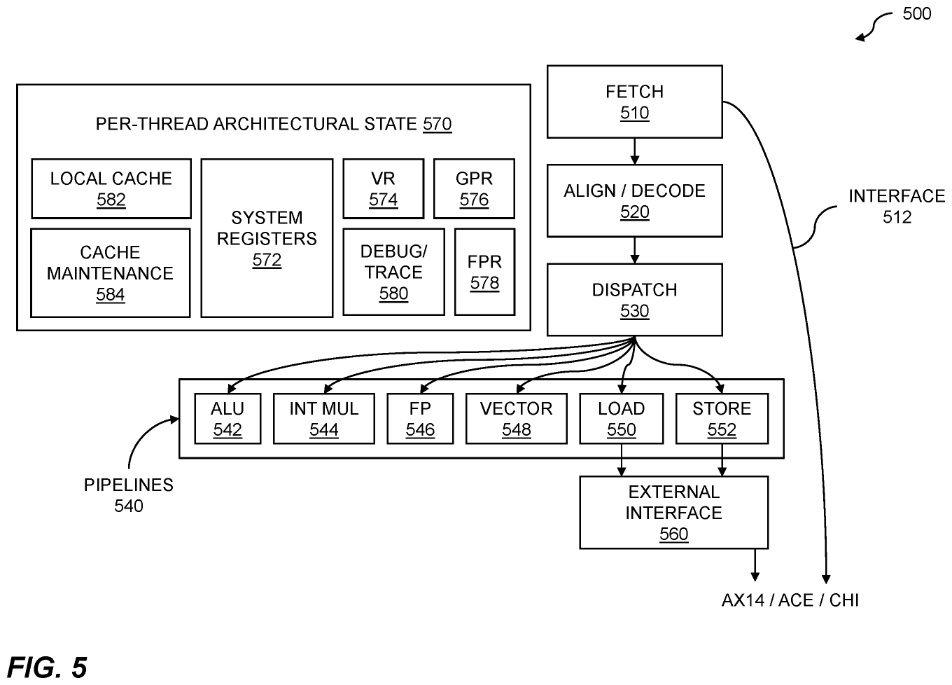

FIG. 5 is a block diagram for a pipeline. The use of one or more pipelines associated with a processor architecture can greatly enhance processing throughput. The processing throughput can be increased because multiple operations can be executed in parallel. The use of one or more pipelines supports processor and network-on-chip coherency management. A plurality of processor cores is accessed, wherein each processor of the plurality of processor cores accesses a common memory through a coherent network-on-chip, and wherein the coherent network-on-chip comprises a global coherency. A local cache is coupled to a grouping of two or more processor cores of the plurality of processor cores, wherein the local cache is shared among the two or more processor cores, wherein the grouping of two or more processor cores and the shared local cache operates using local coherency, and wherein the local coherency is distinct from the global coherency. A cache maintenance operation is performed in the grouping of two or more processor cores and the shared local cache, wherein the cache maintenance operation generates cache coherency transactions between the global coherency and the local coherency.

The FIG. 500 shows a block diagram of a pipeline such as a core pipeline. The blocks within the block diagram can be configurable in order to provide varying processing levels. The varying processing levels can be based on processing speed, bit lengths, and so on. The block diagram 500 can include a fetch block 510. The fetch block can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 512. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 500 includes an align and decode block 520. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decode packets. The decode packets can be used in the pipeline to manage execution of operations. The system block diagram 500 can include a dispatch block 530. The dispatch block can receive decoded instruction packets from the align and decode block. The decode instruction packets can be used to control a pipeline 540, where the pipeline can include an in-order pipeline, an out-of-order (OoO) pipeline, etc. For the case of an in-order pipeline, the dispatch block can maintain a register “scoreboard” and can forward instruction packets to various processors for execution. For the case of an out-of-order pipeline, the dispatch block can perform additional operations from the instruction set. Instructions can be issued by the dispatch block to one or more execution units. A pipeline can be associated with the one or more execution units. The pipelines associated with the execution units can include processor cores, arithmetic logic unit (ALU) pipelines 542, integer multiplier pipelines 544, floating-point unit (FPU) pipelines 546, vector unit (VU) pipelines 548, and so on. The dispatch unit can further dispatch instructions to pipes that can include load pipelines 550, and store pipelines 552. The load pipelines and the store pipelines can access storage such as the common memory using an external interface 560. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, the plurality of processors can be configured to support multi-threading. The system block diagram can include a per-thread architectural state block 570. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 572. The system registers can be associated with individual processors, a system comprising multiple processors, and so on. The system registers can include exception and interrupt components, counters, etc. The per-thread architectural state can include further registers such as vector registers (VR) 574, general purpose registers (GPR) 576, and floating-point registers 578. These registers can be used for vector operations, general purpose (e.g., integer) operations, and floating-point operations, respectively. The per-thread architectural state can include a debug and trace block 580. The debug and trace block can enable debug and trace operations to support code development, troubleshooting, and so on. In embodiments, an external debugger can communicate with a processor through a debugging interface such as a joint test action group (JTAG) interface. The per-thread architectural state can include local cache state 582. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 584. The cache maintenance state can include maintenance needed, maintenance pending, and maintenance complete states, etc.

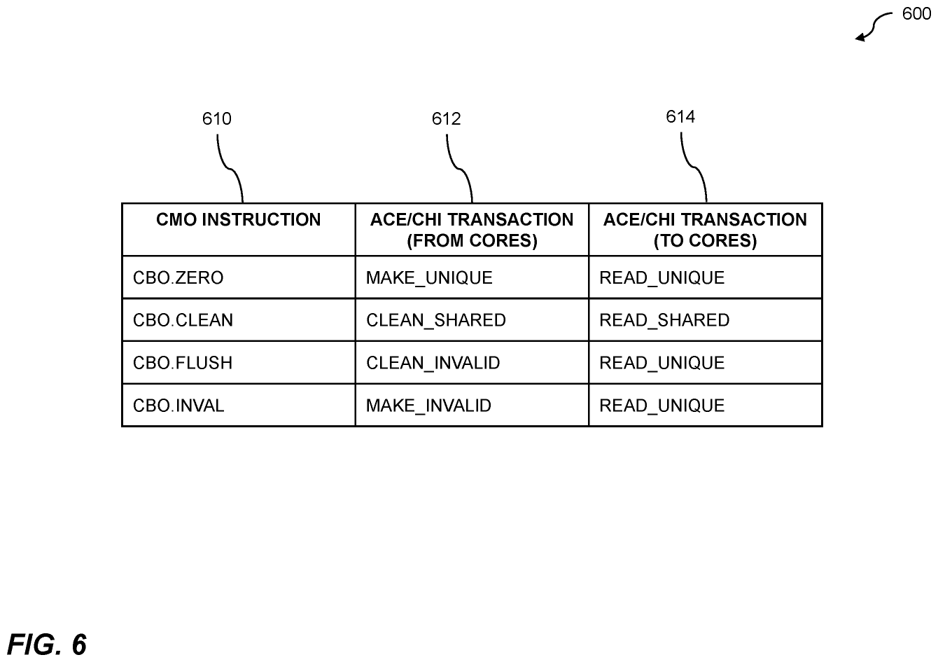

FIG. 6 is a table 600 showing cache maintenance operations (CMOs). Coherency management between a common memory shared by processors, and local caches associated with groupings of two or more processors, must be maintained in order to support effective processing. While the use of multiple local caches can greatly increase overall processing of applications such as parallel processing applications, the processing is ineffective if the data that is being processed is “stale” or “dirty”, if new data is written over data before the latter data can be processed, and so on. The use of multiple local caches can reduce shared memory access contention, as well as access contention to a single cache. Supporting the multiple local caches greatly complicates storage coherency because multiple copies of the same data can be loaded into multiple caches. The processors that access the data in the local caches can change the local copies of the data. Cache maintenance operations enable processor and network-on-chip coherency management. A plurality of processor cores is accessed, wherein each processor of the plurality of processor cores accesses a common memory through a coherent network-on-chip, and wherein the coherent network-on-chip comprises a global coherency. A local cache is coupled to a grouping of two or more processor cores of the plurality of processor cores, wherein the local cache is shared among the two or more processor cores, wherein the grouping of two or more processor cores and the shared local cache operates using local coherency, and wherein the local coherency is distinct from the global coherency. A cache maintenance operation is performed in the grouping of two or more processor cores and the shared local cache, wherein the cache maintenance operation generates cache coherency transactions between the global coherency and the local coherency.

In embodiments, the cache maintenance operations (CMOs) 610 can be supported by the processor architecture such as a RISC-V™ architecture. The operations can include privileged instructions in order to access the common memory, the local caches, and so on. A subset of the cache maintenance operations can include cache block operations (CBOs). The cache block operations can accomplish a variety of data handling operations such as setting a state of all local caches into a particular state with respect to the common memory. The CBO operations can be applied to caches such as local caches within a coherency domain. The coherency domain can include the common memory, the local caches associated with groupings of processors, and so on. In order for the CBO operations to be performed within the coherency domain, the CBO operations can be mapped to standardized cache transactions. The standardized cache transactions can be associated with a processor type, an industry standard, and so on. In embodiments, standardized transactions can include cache maintenance operations supporting cache transactions such as ARM™ Advanced extensible Interface (AXI™) Coherence Extensions (ACE™) cache transactions, Advanced Microcontroller Bus Architecture (AMBA™) Coherence Hub Interface (CHI™) transactions, etc. The mappings of the CBOs can be different for transactions originating from cores or caches to cores globally, and to cores and caches locally in a compute coherency block (CCB). In embodiments, the cache coherency transactions can be issued globally before being issued locally. The issuing globally before issuing locally can accomplish saving new data to the common memory and sharing the new data to the other local caches. In embodiments, the cache coherency transactions that are issued globally can complete before cache coherency transactions are issued locally.

The cache maintenance operations can include a cache block operation cbo.zero. The operation cbo.zero can be mapped to an ACE or CHI transaction 612 from a core to cores globally, to cores locally, and so on. In embodiments, the cache coherency transactions can include issuing a Make_Unique operation globally and a Read_Unique operation locally, based on a cache maintenance operation of cache line zeroing. The cache maintenance operations can include a cache block operation cbo.clean. The operation cbo.clean can be mapped to an ACE or CHI transaction 614 from a core to cores globally, to cores locally, and the like. In embodiments, the cache coherency transactions can include issuing a Clean_Shared operation globally and a Read_Shared operation locally, based on a cache maintenance operation of cache line cleaning. The cache maintenance operations can include a cache block operation cbo.flush. The operation cbo.flush can be mapped to an ACE or CHI transaction from a core to cores globally, to cores locally, etc. In embodiments, the cache coherency transactions can include issuing a Clean_Invalid operation globally and a Read_Unique operation locally, based on a cache maintenance operation of cache line flushing. The cache maintenance operations can further include a cache block operation cbo.inval (e.g., invalid). The operation cbo.inval can also be mapped to an ACE or CHI transaction from a core to cores globally, to cores locally, and so on. In embodiments, the cache coherency transactions can include issuing a Make_Invalid operation globally and a Read_Unique operation locally, based on a cache maintenance operation of cache line invalidating.

In embodiments, the cache maintenance operation can include cache block operations. The cache block operation can include moving data such as a block of data, replacing data, clearing data, and so on. In embodiments, the cache block operations can include a cache line zeroing operation, a cache line cleaning operation, a cache line flushing operation, and a cache line invalidating operation. The cache block operations can be executed for one or more local caches. In embodiments, the cache line zeroing operation can include uniquely allocating a cache line at a given physical address with zero value. Setting a cache line to a specific value such as zero can accomplish a reset, indicate that no data is available, set the cache line to a known value rather than leaving the cache line in an unknown state, etc. In embodiments, the cache line cleaning operation can include making all copies of a cache line at a given physical address consistent with that of memory. Recall that local caches can each be associated with a grouping of processors. Cleaning all cache lines at a given address ensures that the processor groupings can execute operations on consistent data. In embodiments, the cache line flushing operation can include flushing any dirty data for a cache line at a given physical address to memory and then invalidating any and all copies. The cache line data can become stale or “dirty” as a result of the data within the cache line being updated by operations executed by processors associated with the cache line. Flushing the dirty data to the common memory can change the contents of the common memory, and by doing so, invalidating copies of the un-updated cache line data within the other cache lines. In embodiments, the cache line invalidating operation comprises invalidating any and all copies of a cache line at a given physical address without flushing dirty data. The cache line invalidating can result from a branch decision, an exception, and the like.

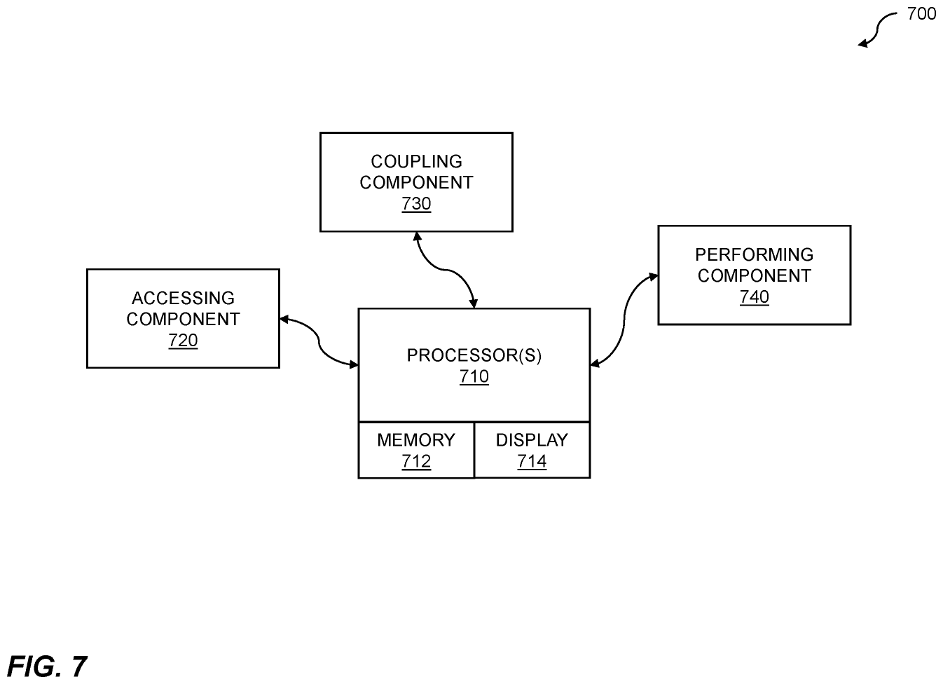

FIG. 7 is a system diagram for processor and coherency management, where the coherency management is enabled by processor and network-on-chip coherency management. The system can include one or more of processors, memories, cache memories, displays, and so on. The system 700 can include one or more processors 710. The processors can include standalone processors within integrated circuits or chips, processor cores in FPGAs or ASICs, and so on. The one or more processors 710 are attached to a memory 712, which stores operations. The memory can include one or more of local memory, cache memory, system memory, etc. The system 700 can further include a display 714 coupled to the one or more processors 710. The display 714 can be used for displaying data, instructions, operations, and the like. The operations can include cache maintenance operations. The operations can further include cache maintenance operations, Advanced extensible Interface (AXI) Coherence Extensions (ACE) cache transactions, Advanced Microcontroller Bus Architecture (AMBA™) Coherence Hub Interface (CHI™) transactions, etc. In embodiments, one or more processors 710 are coupled to the memory 712, wherein the one or more processors, when executing the instructions which are stored, are configured to: access a plurality of processor cores, wherein each processor of the plurality of processor cores accesses a common memory through a coherent network-on-chip, wherein the coherent network-on-chip comprises a global coherency; couple a local cache to a grouping of two or more processor cores of the plurality of processor cores, wherein the local cache is shared among the two or more processor cores, wherein the grouping of two or more processor cores and the shared local cache operates using local coherency, and wherein the local coherency is distinct from the global coherency; and perform a cache maintenance operation in the grouping of two or more processor cores and the shared local cache, wherein the cache maintenance operation generates cache coherency transactions between the global coherency and the local coherency.

The system 700 can include an accessing component 720. The accessing component 720 can access a plurality of processor cores. The processor cores can be accessed with one or more chips, FPGAs, ASICs, etc. In embodiments, the processor cores can include RISC-V™ processor cores. Each processor of the plurality of processor cores accesses a common memory through a coherent network-on-chip. The common memory can include on-chip memory, off-chip memory, etc. The coherent network-on-chip comprises a global coherency. The coherency can include coherency between the shared memory and cache memory, such as level 1 (L1) cache memory. L1 cache memory can include local cache coupled to groupings of two or more processor cores (described below). The coherency between the shared memory and one or more local cache memories can be accomplished using cache maintenance operations (CMOs), described previously.

The system 700 can include a coupling component 730. The coupling component 730 can couple a local cache to a grouping of two or more processor cores of the plurality of processor cores. The local cache is shared among the two or more processor cores. The grouping of two or more processor cores and the shared local cache operates using local coherency. The coherency of the local cache can be enabled with respect to the two or more processor cores coupled to the local cache using one or more change bits such as a “dirty” bit, operation precedence or priority, and the like. Embodiments can include coupling an additional local cache to an additional grouping of two or more additional processor cores. The additional local cache and the additional grouping of additional processors can be colocated with the local cache and processors discussed previously, or can be separate from the local cache and processors. The local caches and their associated groupings of processors can include caches and processors within one or more chips, cache cores and processor cores within one or more FPGAs or ASICS, etc. In embodiments, the additional local cache can be shared among the additional groupings of two or more additional processor cores and operates using the local coherency. The local coherency is distinct from the global coherency. That is, local caches can provide data to and receive data from the grouping of processors associated with the local cache. The cache and local processors can perform operations prior to writing back to the common memory.

The system 700 can include a performing component 740. The performing component 740 can perform a cache maintenance operation in the grouping of two or more processor cores and the shared local cache. Various cache maintenance operations (CMOs) can be performed. The cache maintenance operations can include a subset of operations such as cache block operations (CBOs). The cache block operations can update a state associated with all caches such as the local L1 caches. The updated state can include a specific state with respect to the shared memory. In embodiments, the cache block operations can include zeroing a cache line; making all copies of a cache line consistent with a cache line from the shared memory while leaving the consistent copies in the local caches; flushing “dirty” data for a cache line then invalidating copies of the flushed, dirty data; and invalidating copies of a cache line without flushing dirty data to the shared memory. The cache maintenance operation generates cache coherency transactions between the global coherency and the local coherency. Maintaining the local cache coherency and the global coherency is complicated by the use of a plurality of local caches. Recall that a local cache can be coupled to a grouping of two or more processors. While the plurality of local caches can enhance operation processing by the groupings of processors, there can be more than one dirty copy of one or more cache lines present in any given local cache. Thus, the maintaining of the coherency of the contents of the caches and the system memory can be carefully orchestrated to ensure that valid data is not overwritten, stale data is not used, etc. The cache maintenance operations can be enabled by an interconnect. In embodiments, the grouping of two or more processor cores and the shared local cache can be interconnected to the grouping of two or more additional processor cores and the shared additional local cache using the coherent network-on-chip. In embodiments, the system 700 implements coherency management through implementation of semiconductor logic. One or more processors can execute instructions which are stored to generate semiconductor logic to: access a plurality of processor cores, wherein each processor of the plurality of processor cores accesses a common memory through a coherent network-on-chip, and wherein the coherent network-on-chip comprises a global coherency; couple a local cache to a grouping of two or more processor cores of the plurality of processor cores, wherein the local cache is shared among the two or more processor cores, wherein the grouping of two or more processor cores and the shared local cache operates using local coherency, and wherein the local coherency is distinct from the global coherency; and perform a cache maintenance operation in the grouping of two or more processor cores and the shared local cache, wherein the cache maintenance operation generates cache coherency transactions between the global coherency and the local coherency.

The system 700 can include a computer program product embodied in a non-transitory computer readable medium for coherency management, the computer program product comprising code which causes one or more processors to generate semiconductor logic for: accessing a plurality of processor cores, wherein each processor of the plurality of processor cores accesses a common memory through a coherent network-on-chip, and wherein the coherent network-on-chip comprises a global coherency; coupling a local cache to a grouping of two or more processor cores of the plurality of processor cores, wherein the local cache is shared among the two or more processor cores, wherein the grouping of two or more processor cores and the shared local cache operates using local coherency, and wherein the local coherency is distinct from the global coherency; and performing a cache maintenance operation in the grouping of two or more processor cores and the shared local cache, wherein the cache maintenance operation generates cache coherency transactions between the global coherency and the local coherency.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for coherency management comprising:
accessing a plurality of processor cores, wherein each processor of the plurality of processor cores accesses a common memory through a coherent network-on-chip, and wherein the coherent network-on-chip comprises a global coherency;
coupling a local cache to a grouping of two or more processor cores of the plurality of processor cores, wherein the local cache is shared among the two or more processor cores, wherein the grouping of two or more processor cores and the shared local cache operates using local coherency, and wherein the local coherency is distinct from the global coherency; and
performing a cache maintenance operation in the grouping of two or more processor cores and the shared local cache, wherein the cache maintenance operation generates cache coherency transactions between the global coherency and the local coherency.

2. The method of claim 1 further comprising coupling an additional local cache to an additional grouping of two or more additional processor cores.

3. The method of claim 2 wherein the additional local cache is shared among the additional grouping of two or more additional processor cores and operates using the local coherency.

4. The method of claim 3 wherein the grouping of two or more processor cores and the shared local cache is interconnected to the grouping of two or more additional processor cores and the shared additional local cache using the coherent network-on-chip.

5. The method of claim 1 wherein the cache coherency transactions enable coherency among the plurality of processor cores, one or more local caches, and the memory.

6. The method of claim 1 wherein the cache coherency transactions are issued globally before being issued locally.

7. The method of claim 6 wherein the cache coherency transactions that are issued globally complete before cache coherency transactions that are issued locally.

8. The method of claim 7 wherein an indication of completeness comprises a response from the coherent network-on-chip.

9. The method of claim 6 wherein the cache coherency transactions include issuing a Make_Unique operation globally and a Read_Unique operation locally, based on a cache maintenance operation of cache line zeroing.

10. The method of claim 6 wherein the cache coherency transactions include issuing a Clean_Shared operation globally and a Read_Shared operation locally, based on a cache maintenance operation of cache line cleaning.

11. The method of claim 6 wherein the cache coherency transactions include issuing a Clean_Invalid operation globally and a Read_Unique operation locally, based on a cache maintenance operation of cache line flushing.

12. The method of claim 6 wherein the cache coherency transactions include issuing a Make_Invalid operation globally and a Read_Unique operation locally, based on a cache maintenance operation of cache line invalidating.

13. The method of claim 1 wherein the cache maintenance operation includes cache block operations.

14. The method of claim 13 wherein the cache block operations include a cache line zeroing operation, a cache line cleaning operation, a cache line flushing operation, and a cache line invalidating operation.

15. The method of claim 14 wherein the cache line zeroing operation comprises uniquely allocating a cache line at a given physical address with zero value.

16. The method of claim 14 wherein the cache line cleaning operation comprises making all copies of a cache line at a given physical address consistent with that of memory.

17. The method of claim 14 wherein the cache line flushing operation comprises flushing any dirty data for a cache line at a given physical address to memory and then invalidating any and all copies.

18. The method of claim 14 wherein the cache line invalidating operation comprises invalidating any and all copies of a cache line at a given physical address without flushing dirty data.

19. The method of claim 1 wherein the grouping of two or more processor cores and the shared local cache comprises a tightly coupled compute coherency block.

20. The method of claim 1 wherein the cache maintenance operation is a privileged instruction within the plurality of processor cores.

21. A computer program product embodied in a non-transitory computer readable medium for coherency management, the computer program product comprising code which causes one or more processors to generate semiconductor logic for:
accessing a plurality of processor cores, wherein each processor of the plurality of processor cores accesses a common memory through a coherent network-on-chip, and wherein the coherent network-on-chip comprises a global coherency;
coupling a local cache to a grouping of two or more processor cores of the plurality of processor cores, wherein the local cache is shared among the two or more processor cores, wherein the grouping of two or more processor cores and the shared local cache operates using local coherency, and wherein the local coherency is distinct from the global coherency; and
performing a cache maintenance operation in the grouping of two or more processor cores and the shared local cache, wherein the cache maintenance operation generates cache coherency transactions between the global coherency and the local coherency.

22. A computer system for coherency management comprising:
a memory which stores instructions;
one or more processors coupled to the memory wherein the one or more processors, when executing the instructions which are stored, generate semiconductor logic to:
access a plurality of processor cores, wherein each processor of the plurality of processor cores accesses a common memory through a coherent network-on-chip, and wherein the coherent network-on-chip comprises a global coherency;
couple a local cache to a grouping of two or more processor cores of the plurality of processor cores, wherein the local cache is shared among the two or more processor cores, wherein the grouping of two or more processor cores and the shared local cache operates using local coherency, and wherein the local coherency is distinct from the global coherency; and
perform a cache maintenance operation in the grouping of two or more processor cores and the shared local cache, wherein the cache maintenance operation generates cache coherency transactions between the global coherency and the local coherency.
